(19) United States
(12) Patent Application Publication
(10) Pub. No.: US 2021/0079143 A1
(43) Pub. Date: Mar. 18, 2021

(54) STRENGTHENING RESINS AND PROCESSES FOR MAKING AND USING SAME

(71) Applicant: ECOLAB USA INC., St. Paul, MN (US)

(72) Inventors: Gary S. Furman, St. Charles (US); En-Wei Lin, Naperville, IL (US); Mei Liu, Plainfield, IL (US); David J. Castro, DeKalb, IL (US); Christopher D. Kaley, Hoffman Estates, IL (US)

(73) Assignee: ECOLAB USA INC., St. Paul, MN (US)

(21) Appl. No.: 16/983,685

(22) Filed: Aug. 3, 2020

Related U.S. Application Data
(60) Provisional application No. 62/900,280, filed on Sep. 13, 2019.

(51) Int. Cl. C08F 220/58; D21H 21/18; D21H 17/45

(52) U.S. Cl. CPC C08F 220/58; C08F 2800/10; D21H 17/455; D21H 21/18

(57) ABSTRACT

Strengthening resins and processes for making and using same. In some embodiments, a resin mixture can include a solvent and a strengthening resin. The strengthening resin can include one or more hydrophobic monomers incorporated therein. The strengthening resin can have a chemical formula of (I). The chemical formula (I) can include:

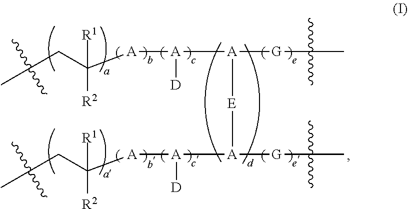

where each R² can be derived from a hydrophobic monomer.

### CROSS REFERENCE TO RELATED APPLICATION

This application claims priority to U.S. Provisional Patent Application No. 62/900,280, filed on Sep. 13, 2019, which is incorporated by reference herein.

### BACKGROUND

### Field

Embodiments described generally relate to strengthening resins and process for making and using same. More particularly, such embodiments relate to strengthening resins, e.g., glyoxalated polyacrylamide, that include one or more hydrophobic monomers incorporated therein and processes for making and using same.

### Description of the Related Art

Paper is sheet material containing interconnected small, discrete fibers. The fibers are usually formed into a sheet on a fine screen from a dilute water suspension or slurry. Typically paper is made from cellulose fibers, although occasionally synthetic fibers are used. The wet strength of paper is defined (U.S. Pat. No. 5,585,456) as the resistance of the paper to rupture or disintegration when it is wetted with water. Paper products made from untreated cellulose fibers lose their strength rapidly when they become wet, i.e., they have very little wet strength. Wet strength of ordinary paper is only about 5% of its dry strength. Various processes of treating paper products have been employed to overcome this disadvantage.

Wet strength resins applied to paper are either of the “permanent” or “temporary” type, which are defined by how long the paper retains its wet strength after immersion in water. While permanent wet strength is a desirable characteristic in packaging materials, it presents a disposal problem. Paper products having permanent wet strength are typically degradable only under undesirably severe conditions. While some resins are known to impart temporary wet strength (temporary wet strength resins) and would be suitable for sanitary or disposable paper uses, they often suffer from one or more drawbacks. For example, the temporary wet strength resins generally do not provide an optimal combination of dry and wet strength or softness properties to the sanitary or disposable paper products. There is a need, therefore, for improved processes for imparting appropriate levels of wet strength and/or repulpability to paper products.

### SUMMARY

Strengthening resins and processes for making and using same are provided. In some embodiments, a resin mixture can include a solvent and a strengthening resin. The solvent can be selected from the group consisting of: water, methanol, ethanol, acetonitrile, and a mixture thereof. The strengthening resin can have a chemical formula of (I), where the chemical formula (I) includes:

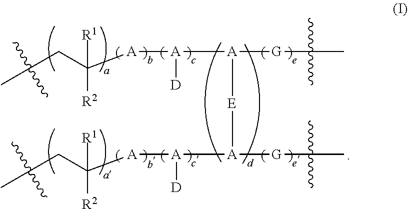

In some embodiments, each A repeating unit can be derived from a monomer comprising an aldehyde-reactive moiety, each A-D moiety can be derived from a reaction between an A repeating unit and an aldehyde, each A-E-A moiety can be derived from a reaction between two A repeating units and an aldehyde, each G repeating unit can be derived from a monomer that can be free of an aldehyde reactive moiety that includes N,N-dimethylacrylamide, N,N-diethylacrylamide, N-isopropylacrylamide, N-isopropylmethacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, vinyl acetate, vinyl alcohol, acrylic acid, a salt of acrylic acid, methacrylic acid, a salt of methacrylic acid, 2-acrylamido-2-methylpropanesulfonic acid, a sodium salt of 2-acrylamido-2-methylpropanesulfonic acid, sodium vinyl sulfonate, styrene sulfonate, maleic acid, a salt of maleic acid, sulfonate, itaconate, sulfopropyl acrylate, sulfopropyl methacrylate, a monoallyl amine, a diallyl amine, a vinyl amine, a dialkylaminoalkyl acrylate, a quaternary dialkylaminoalkyl acrylate, a salt of a dialkylaminoalkyl acrylate, a dialkylaminoalkyl methacrylate, a quaternary dialkylaminoalkyl methacrylate, a salt of a dialkylaminoalkyl methacrylate, a dialkylaminoalkylacrylamide, a quaternary dialkylaminoalkylacrylamide, a salt of a dialkylaminoalkylacrylamide, a dialkylaminoalkyl methacrylamide, a quaternary dialkylaminoalkyl methacrylamide, a salt of a dialkylaminoalkyl methacrylamide, a diallyldiethylammonium chloride, a diallyldimethyl ammonium chloride, N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl) ammonium betaine, or a mixture thereof. In some embodiments, the total mol % of a and a′ can be equal to about 0.05 mol % to about 5 mol %, the total mol % of b and b′ can be equal to about 30 mol % to about 90 mol %, the total mol % of c and c′ can be equal to about 4 mol % to about 40 mol %, the total mol % of d can be equal to about 2 mol % to about 20 mol %, and the total mol % of e and e′ can be equal to 2 mol % to about 50 mol %, where all mol % values are based on a combined amount of each a, each a′, each b, each b′, each c, each c′, each d, each e, and each e′. In some embodiments, each R¹ can be a hydrogen atom, a methyl group, or an ethyl group, each R² can be derived from a hydrophobic cationic monomer having a chemical formula of (II), (III), or (IV), where: the chemical formula (II) includes:

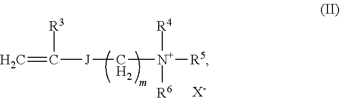

the chemical formula (III) comprises:

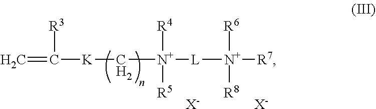

and
the chemical formula (IV) includes:

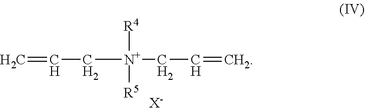

In some embodiments, R³ can be a hydrogen atom, a methyl group, or an ethyl group, J and K can independently be —CH₂—, —O—, —C(O)O—, —C(O)NH—, or arylene, R⁴, R⁵, R⁶, R⁷ and R⁸ can independently be a hydrogen atom, a linear or branched C1-C30 alkyl group, a linear or branched C1-C30 hydroxyalkyl group, or a linear or branched C1-C30 aminoalkyl group, m and n can independently be an integer of 0 to 6, L can be a linear or branched C2-C12 hydrocarbon chain, and X⁻ can be independently a counter ion selected from the group consisting of: chloride, bromide, iodide, hydroxide, phosphate, sulfate, hydrosulfate, ethyl sulfate, methyl sulfate, formate, and acetate.

As used herein, the term “derived” when referring to a monomer unit, means that the monomer unit has substantially the same structure of a monomer from which it was made, where the terminal ethenyl has been transformed during the process of polymerization. For example, when a carbon-carbon double bond of a terminal ethenyl is transformed to a carbon-carbon single bond during the process of polymerization. As used herein, term “aldehyde-reactive moiety” means a functional group that is capable of reacting with an aldehyde.

In some embodiments, a process for making a paper product can include adding a strengthening resin to a slurry that can include a plurality of fibers and water to produce a resinated furnish. The resinated furnish can be formed into a wet paper web. The wet paper web can be pressed and drained to produce a wet paper sheet. The wet paper sheet can be dried to produce a paper product. The strengthening resin can have the chemical structure (I). In some embodiments, the strengthening resin can be added to the slurry as a resin mixture that includes a solvent and the strengthening resin. In some embodiments, the solvent can be selected from the group consisting of water, methanol, ethanol, acetonitrile, and a mixture thereof.

In some embodiments, a process for making a strengthening resin can include reacting a first mixture that can include a first monomer, a second monomer, and a third monomer to produce a prepolymer. The first monomer can be or can include the hydrophobic cationic monomer having the chemical formula of (II), (III), or (IV). The second monomer can be or can include acrylamide, methacrylamide, or a mixture thereof. The third monomer can have a different chemical structure with respect to the first monomer and the second monomer, can be hydrophilic or hydrophobic, and can be or can include a cationic monomer, an anionic monomer, a zwitterionic monomer, a nonionic monomer, or a mixture thereof. The process can also include reacting a second mixture that can include the prepolymer and an aldehyde to produce the strengthening resin. The aldehyde can be or can include formaldehyde, paraformaldehyde, glutaraldehyde, glyoxal, or a mixture thereof.

### DETAILED DESCRIPTION

It has been surprisingly and unexpectedly discovered that incorporating one or more hydrophobic moieties, blocking hydrogen bonding sites, and/or reducing hydrogen bonding sites in a structure of a strengthening resin, e.g., glyoxalated polyacrylamide, can significantly affect the performance of the strengthening resin in a fiber product, e.g., tissue and/or towel products. For example, the dry tensile strength of the fiber product can decrease while the wet tensile strength of the fiber product can remain substantially constant to provide a greater wet over dry strength ratio, which can be a desirable property in fiber products. Without wishing to be bound by theory, it is also believed that incorporating one or more hydrophobic moieties, blocking hydrogen bonding sites, and/or reducing hydrogen bonding sites in the structure of the strengthening resin can significantly increase the softness of the fiber product, which can also be a desirable property in fiber products. In some embodiments, the strengthening resin can be in a resin mixture that includes a solvent and the strengthening resin. In some embodiments, the solvent can be or can include water, methanol, ethanol, acetonitrile, or a mixture thereof.

The strengthening resin can have a chemical structure (I) of:

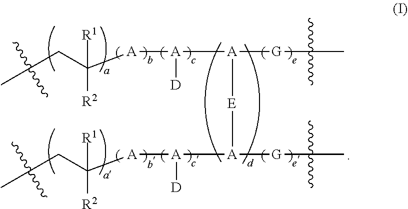

Each “A” repeating unit can be derived from a monomer that includes an aldehyde-reactive moiety. Each “A-D” moiety can be derived from a reaction between an “A” repeating unit and an aldehyde. Each “A-E-A” moiety can be derived from a reaction between two “A” repeating units and an aldehyde. Each “G” repeating unit can be derived from a monomer that can be free of an aldehyde reactive moiety and can be a nonionic monomer, an anionic monomer, a cationic monomer, a zwitterionic monomer, or any mixture thereof.

In chemical structure (I), a total mol % of “a” and “a′” can be equal to about 0.05 mol %, about 0.1 mol %, or about 0.5 mol % to about 1 mol %, about 2 mol %, about 3 mol %, about 4 mol %, or about 5 mol %. In chemical structure (I), a total mol % of “b” and “b′” can be equal to about 30 mol %, about 40 mol %, about 50 mol %, or about 55 mol % to about 70 mol %, about 80 mol %, or about 90 mol %. In chemical structure (I), a total mol % of “c” and “c′” can be equal to about 4 mol %, about 6 mol %, about 8 mol %, or about 10 mol % to about 20 mol %, about 25 mol %, about 30 mol %, about 35 mol %, or about 40 mol %. In chemical structure (I), a total mol % of “d” can be equal to about 2 mol %, about 3 mol %, 4 mol %, or about 5 mol % to about 10 mol %, about 12 mol %, about 16 mol %, about 18 mol %, or about 20 mol %. In chemical structure (I), a total mol % of “e” and “e′” can be equal to about 2 mol %, about 3 mol %, about 5 mol %, about 7 mol %, or about 10 mol % to about 25 mol %, about 30 mol %, about 40 mol %, or about 50 mol %. The total mol % values associated with “a”, “a′”, “b”, “b′”, “c”, “c′”, “d”, “e” and “e′” are based on a combined amount of each “a”, each “a′”, each “b”, each “b′”, each “c”, each “c′”, each “d”, each “e”, and each “e′”.

In some embodiments, in chemical structure (I), the total mol % of “a” and “a′” can be equal to about 0.05 mol % to about 5 mol %, the total mol % of “b” and “b′” can be equal to about 30 mol % to about 90 mol %, the total mol % of “c” and “c′” can be equal to about 4 mol % to about 40 mol %, the total mol % of “d” can be equal to about 2 mol % to about 20 mol %, and the total mol % of “e” and “e′” can be equal to 2 mol % to about 50 mol %, where all mol % values are based on a combined amount of each “a”, each “a′”, each “b”, each “b′”, each “c”, each “c′”, each “d”, each “e”, and each “e′”. In other embodiments, in chemical structure (I), the total mol % of “a” and “a′” can be equal to about 0.1 mol % to about 2 mol %, the total mol % of “b” and “b′” can be equal to about 50 mol % to about 80 mol %, the total mol % of “c” and “c′” can be equal to about 10 mol % to about 30 mol %, the total mol % of “d” can be equal to about 3 mol % to about 12 mol %, the total mol % of “e” and “e′” can be equal to about mol % to about 25 mol %, where all mol % values are based on the combined amount of each “a”, each “a′”, each “b”, each “b′”, each “c”, each “c′”, each “d”, each “e”, and each “e′”.

Each R¹ can be a hydrogen atom, a methyl group, or an ethyl group. Each R² can be derived from a hydrophobic cationic monomer having a chemical formula of (II), (III), or (IV).

The chemical formula (II) can be:

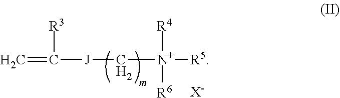

The chemical formula (III) can be:

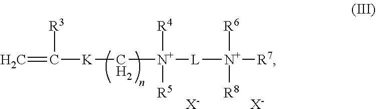

and

The chemical formula (3) can be:

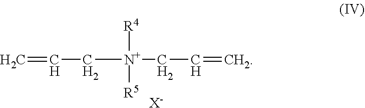

In chemical formulas (II), (III), and (IV), R³ can be a hydrogen atom, a methyl group, or an ethyl group; J and K can independently be —CH₂—, —O—, —C(O)O—, —C(O)NH—, or arylene, e.g., phenylene; R⁴, R⁵, R⁶, R⁷ and R⁸ can independently be a hydrogen atom, a linear or branched C1-C30 alkyl group, a linear or branched C1-C30 hydroxyalkyl group, or a linear or branched C1-C30 aminoalkyl group; “m” and “n” can independently be an integer of 0 to 6, e.g., 0, 1, 2, 3, 4, 5, or 6; L can be a linear or branched C2-C12 hydrocarbon chain, and each X⁻ can independently be a counter ion selected from the group consisting of: chloride, bromide, iodide, hydroxide, phosphate, sulfate, hydrosulfate, ethyl sulfate, methyl sulfate, formate, and acetate.

In some embodiments, the hydrophobic cationic monomer (R²) can be or can include, but is not limited to, p-vinylbenzyldimethyloctadecylammonium chloride (CAS No. 56113-53-2); acryloxyethyl dimethyl lauryl ammonium bromide (CAS No. 150956-26-6); dodcyldimethyl(2-methacryloyloxyethyl)ammonium bromide (CAS No. 96526-35-1); dimethyl(3-acrylamidopropyl)dodecylammonium (CAS No. 350237-51-3); dimethyl(3-methacrylamidopropyl)dodecylammonium (CAS No. 129684-48-6); 1,4-butanediammonium, N1-dodecyl-N1,N1,N4,N4-tetramethyle-N4-2-propen-1-yl-, bromide (CAS No. 1948208-18-1); p-vinylbenzyldimethyldodecylammonium chloride (CAS No. 56307-84-7); or any mixture thereof.

In some embodiments, L can be —CH₂—CH(OH)—CH₂—. In other embodiments, the linear or branched C2-C12 hydrocarbon chain of L can include one or more heteroatoms, e.g., 0, one or more heterogroups, e.g., NH, or a combination thereof. In still other embodiments, the linear or branched C2-C12 hydrocarbon chain of L can be substituted with one or more hydroxy groups, one or more amino groups, or a combination thereof.

As used herein, the term “substituted” means that one or more hydrogens on the designated atom or group are replaced with another group provided that the normal valence of the designated atom is not exceeded. For example, when the substituent is oxo (i.e., ═O), then two hydrogens on the carbon atom are replaced. Combinations of substituents are permissible provided that the substitutions do not significantly adversely affect synthesis or use of the strengthening resin.

It should be understood that any two similar repeating units, e.g., any two “A” repeating units or any two “G” repeating units, can be derived from two or more monomers having the same chemical structure or two or more monomers having different chemical structures. For example, a first “A” repeating units can be derived from a first non-ionic water-soluble monomer and a second “A” repeating units can be derived from a second non-ionic water-soluble monomer, where the first non-ionic water-soluble monomer is the same or different as the second non-ionic water soluble monomer.

In some embodiments, the monomer that includes the aldehyde reactive moiety from which the “A” repeating unit can be derived can be or can include, but is not limited to, a non-ionic water-soluble monomer. In some embodiments, the monomer that includes the aldehyde reactive moiety from which the “A” repeating unit can be derived can be or can include, but is not limited to, acrylamide, methacrylamide, or a mixture thereof.

In some embodiments, the aldehyde from which each “A-D” moiety and each “A-E-A” moiety can be derived from can be or can include, but is not limited to, formaldehyde, paraformaldehyde, glutaraldehyde, glyoxal, malondialdehyde, succindialdehyde, or any mixture thereof. In some embodiments, the aldehyde from which “A-D” moiety and/or “A-E-A” moiety can be derived can be or can include, but is not limited to, formaldehyde, paraformaldehyde, glutaraldehyde, glyoxal, or a mixture thereof. In other embodiments, the aldehyde from which “A-D” moiety and/or “A-E-A” moiety can be derived can be glyoxal. The strengthening resin can include any suitable amount of the aldehyde derived “A-D” moiety and “A-E-A” moiety. Without wishing to be bound by any particular theory, it is believed that the amount of aldehyde derived “A-E-A” moiety has an impact on the viscosity of the resin mixture, such that as the amount of aldehyde derivation increases, the viscosity increases. In some embodiments, the strengthening resin can include about 6 mol % to about 60 mol % (e.g., from about 6 mol % to about 45 mol %, from about 6 mol % to about 30 mol %, from about 6 mol % to about 20 mol %, from about 6 mol % to about 10 mol %, from about 10 mol % to about 60 mol %, from about 10 mol % to about 50 mol %, from about 10 mol % to about 40 mol %, from about 10 mol % to about 30 mol %, or from about 10 mol % to about 20 mol %) of a combined amount of the aldehyde derived “A-D” moiety and the aldehyde derived “A-E-A” moiety. In some embodiments, an amount of the aldehyde derived from “A-D” moiety can be greater than or equal to an amount of the aldehyde derived from “A-E-A” moiety. For example, a molar ratio of the aldehyde derived from “A-D” moiety and the aldehyde derived from “A-E-A” moiety can be about 1:1 to about 5:1 (e.g., from about 1:1 to about 4.5:1, about 1:1 to about 4:1, about 1:1 to about 3.5:1, about 1:1 to about 3:1, about 1.5:1 to about 5:1, about 1.5:1 to about 3.5:1, about 2:1 to about 5:1, about 2.5:1 to about 5:1, about 3:1 to about 5:1, about 2:1 to about 5:1, about 2:1 to about 4:1, about 2:1 to about 3:1).

In some embodiments, the monomer that can be free of an aldehyde reactive moiety that each “G” repeating unit can be derived from can be a nonionic monomer, an anionic monomer, a cationic monomer, a zwitterionic monomer, or any mixture thereof. In some embodiments, the nonionic monomer from which each “G” repeating unit can be derived from can be or can include, but is not limited to, N,N-dimethylacrylamide, N,N-diethylacrylamide, N-isopropylacrylamide, N-isopropylmethacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, vinyl acetate, vinyl alcohol, or a mixture thereof.

In some embodiments, the anionic monomer from which each “G” repeating unit can be derived from can be or can include, but is not limited to, acrylic acid, a salt of acrylic acid, methacrylic acid, a salt of methacrylic acid, 2-acrylamido-2-methylpropanesulfonic acid, a sodium salt of 2-acrylamido-2-methylpropanesulfonic acid, sodium vinyl sulfonate, styrene sulfonate, maleic acid, a salt of maleic acid, a sulfopropyl acrylate, a sulfopropyl methacrylate, a sulfomethylated acrylamide, an allyl sulfonate, itaconic acid, acrylamidomethylbutanoic acid, fumaric acid, vinylphosphonic acid, vinylsulfonic acid, allylphosphonic acid, phosphonomethylated acrylamide, itaconic anhydride, or a mixture thereof.

In some embodiments, the cationic monomer from which each “G” repeating unit can be derived from can be or can include, but is not limited to, a monoallyl amine, a diallyl amine, a vinyl amine, a dialkylaminoalkyl acrylate, a quaternary dialkylaminoalkyl acrylate, a salt of a dialkylaminoalkyl acrylate, a dialkylaminoalkyl methacrylate, a quaternary dialkylaminoalkyl methacrylate, a salt of a dialkylaminoalkyl methacrylate, a dialkylaminoalkylacrylamide, a quaternary dialkylaminoalkylacrylamide, a salt of a dialkylaminoalkylacrylamide, a dialkylaminoalkyl methacrylamide, a quaternary dialkylaminoalkyl methacrylamide, a salt of a dialkylaminoalkyl methacrylamide, diallyldiethylammonium chloride, diallyldimethyl ammonium chloride, or a mixture thereof.

The zwitterionic monomers can be a polymerizable compound that includes cationic and anionic (charged) functionality in equal proportions, so that the overall net charge of the monomer is neutral. In some embodiments, the zwitterionic monomer from which each “G” repeating unit can be derived from can be or can include, but is not limited to, N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl) ammonium betaine, or a mixture thereof.

In some specific embodiments, the strengthening resin can be a glyoxalated polyacrylamide that further includes hydrophobic cationic monomer(s) derived from chemical formula (II), (III), or (IV) incorporated into the prepolymer structure prior to glyoxalation, i.e., reacting with the glyoxal aldehyde. In such an embodiment, each “A” repeating unit can be derived from acrylamide, methacrylamide, or a mixture thereof, each “A-D” moiety and each “A-E-A” moiety can be derived from glyoxal, and each “G” repeating unit can be derived from diallyldimethyl ammonium chloride.

As noted above, in some embodiments, the strengthening resin can be mixed, blended, combined, or otherwise contacted with a solvent to produce a resin mixture. In some embodiments, the strengthening resin can be produced in the presence of the solvent. The solvent can be or can include, but is not limited to, water, methanol, ethanol, acetonitrile, or any mixture thereof. In some embodiments, the resin mixture can include about 3 wt % to about 30 wt % (e.g., about 3 wt % to about 25 wt %, about 3 wt % to about 20 wt %, about 3 wt % to about 15 wt %, about 7 wt % to about 30 wt %, about 7 wt % to about 25 wt %, about 7 wt % to about 20 wt %, about 7 wt % to about 15 wt %, about 10 wt % to about 30 wt %, about 10 wt % to about 25 wt %, about 10 wt % to about 20 wt %, about, or about 10 wt % to about 15 wt %) of the strengthening resin, based on the combined weight of the strengthening resin and solvent.

The resin mixture can include any suitable weight percent of the strengthening resin, based on the combined weight of the solvent and the strengthening resin, referred to as “solids” or “solids content.” It should be understood that should the strengthening resin include any unreacted monomers, e.g., unreacted aldehyde, the solids content would also be based on the unreacted monomers. As such, the resin mixture can include any suitable weight percent of the strengthening resin, based on the combined weight of the solvent, the strengthening resin, and, if present, any unreacted monomer(s), referred to as “solids” or “solids content”. In some embodiments, the resin mixture can include about 3 wt % to about 30 wt % (e.g., about 3 wt % to about 25 wt %, about 3 wt % to about 20 wt %, about 3 wt % to about 15 wt %, about 3 wt % to about 10 wt %, about 5 wt % to 30 wt %, about 5 wt % to about 25 wt %, about 5 wt % to about 20 wt %, about 5 wt % to about 15 wt %, about 5 wt % to about 10 wt %, about 7 wt % to about 30 wt %, about 7 wt % to about 25 wt %, about 7 wt % to about 20 wt %, about 7 wt % to about 15 wt %, about 10 wt % to about 30 wt %, about 10 wt % to about 25 wt %, about 10 wt % to about 20 wt %, or about 10 wt % to about 15 wt %) of a solids content, based on the combined weight of the strengthening resin and solvent. In certain embodiments, the resin mixture can include about 7 wt % to about 12 wt %, such as about 9 wt %, of solids of the strengthening resin.

The strengthening resin can have a weight average molecular weight (M_{w}) of about 50 kDa, about 75 kDa, about 100 kDa, about 250 kDa, or about 500 kDa to about 1,000 kDa, about 2,000 kDa, about 3,000 kDa, about 4,000 kDa, about 5,000 kDa, about 7,000 kDa, about 10,000 kDa, or about 12,000 kDa. The M_{w} can be measured using gel permeation chromatography (“GPC”), also known as size exclusion chromatography (“SEC”). This technique utilizes an instrument containing columns packed with porous beads, an elution solvent, and detector in order to separate polymer molecules of different sizes.

The strengthening resin can be produced by reacting a first reaction mixture or first mixture that includes a first monomer, a second monomer, and a third monomer to produce a prepolymer. The first monomer can be the hydrophobic cationic monomer having chemical formula (II), (III), (IV), or any mixture thereof, the second monomer can be the non-ionic water-soluble monomer, and the third monomer can be the cationic monomer, the anionic monomer, the zwitterionic monomer, the nonionic monomer, or any mixture thereof, where the third monomer has a different chemical structure with respect to the first monomer and the second monomer. The third monomer can be hydrophilic, hydrophobic, or can include a mixture of third monomers with one or more being hydrophilic and one or more being hydrophobic. The reaction or polymerization conditions can be controlled or adjusted to produce a pre-polymer that incudes aldehyde-reactive moieties. The prepolymer can have a weight average molecular weight of about 1 kDa, about 2 kDa, about 5 kDa, or about 10 kDa to about 100 kDa, about 1,000 kDa, or about 10,000 kDa.

The first reaction mixture can be heated to a temperature of about 35° C., about 50° C., about 65° C., or about 80° C. to about 90° C., about 100° C., about 110° C., or about 120° C. for about 15 minutes, about 30 minutes, about 1 hour, or about 3 hours to about 6 hours, about 12 hours, about 24 hours, or about 48 hours to produce the prepolymer. In some embodiments, the first mixture can be prepared by heating the third monomer, e.g., to a temperature of about 80° C. to about 100° C., and adding a mixture of the first monomer and the second monomer over a period of time, e.g., about 15 minutes to about 2 hours, to produce the first reaction mixture that can be allowed to react for a period of time, e.g., about 30 minutes to about 3 hours, to produce the prepolymer. In some embodiments, the first reaction mixture can be reacted under an inert atmosphere, e.g., a nitrogen atmosphere. Synthesis of the prepolymer can be carried out in a batch process, in a semi-batch process, or a continuous process. In batch processes, the first monomer, the second monomer, and the third monomer can be reacted together at the same time. In semi-batch processes, a portion of one or more of the monomers can be withheld from the reaction mixture and added over time to affect the compositional drift of the prepolymer or the formation of dispersion particles. In a continuous process, a mixture of all three monomers can be added over time to a reaction vessel to affect the compositional drift differently than batch or semi-batch processes.

In some embodiments, the first reaction mixture can include one or more additives or first additives. For example, the first additive can be or can include, but are not limited to, one or more chain transfer agents, one or more chelants, one or more initiators, one or more surfactants, or any mixture thereof. Illustrative chain transfer agents can be or can include, but are not limited to, sodium formate, sodium hypophosphite, isopropanol, a mercaptan, e.g., 2-mercaptoethanol, or any mixture thereof. In some embodiments, a molar ratio between a total amount of monomers, i.e., the first monomer, the second monomer, and the third monomer, and the chain transfer agent can be about 1:0 to about 1:0.1 (e.g., about 1:0 to about 1:0.08, about 1:0 to about 1:0.06, about 1:0 to about 1:0.04, about 1:0.01 to about 1:0.1, about 1:0.01 to about 1:0.08, about 1:0.01 to about 1:0.06, about 1:0.1 to about 1:0.04, about 1:0.02 to about 1:0.1, about 1:0.02 to about 1:0.06, about 1:0.02 to about 1:0.04, about 1:0.03 to about 1:0.1, about 1:0.03 to about 1:0.06, or about 1:0.03 to about 1:0.04). Illustrative chelants can be or can include, but are not limited to, ethylenediamine tetraacetic acid, diethylenetriaminepentacetic acid, or a mixture thereof. In some embodiments, a molar ratio between the total monomer, i.e., the first monomer, the second monomer, and the third monomer, and the chelant can be about 1:0 to about 1:0.001 (e.g., 1:0 to about 1:0.0008, about 1:0 to about 1:0.0005, about 1:0 to about 1:0.0001, about 1:0 to about 1:0.00001, about 1:0.00001 to about 1:0.001, about 1:0.00001 to about 1:0.0008, about 1:0.0001 to about 1:0.001, or about 1:0.00005 to about 1:0.001).

The surfactant can be an ionic surfactant. In some embodiments, the surfactant can be or can include, but is not limited to, one or more an alkyl sulfates, one or more tetraalkyl ammoniums, one or more sultaines, one or more betaines, a salt thereof, or any mixture thereof. In some embodiments, the surfactant can be a C8-C24 alkyl sulfate, a C8-C24 alkyl tri(C1-C4 alkyl)ammonium, an alkylamidoalkyl hydroxy sultaine, an alkylaminoalkyl betaine, a salt thereof, or any mixture thereof. In other embodiments, the surfactant can be hexadecyl-trimethyl-ammonium bromide (cetrimonium bromide), cetyltrimethylammonium chloride, sodium dodecyl sulfate, cocamidopropyl hydroxysultaine, cocamidopropyl betaine, polyoxyethylene alkyl alcohol, or any mixture thereof. In some embodiments, a molar ratio between the first monomer (hydrophobic cationic monomer) and the surfactant can be about 1:1 or about 1:2 to about 1:8 or about 1:10.

In some embodiments, the initiator can be or can include, but is not limited to, one or more azo compounds, one or more peroxide compounds, one or more hydroperoxide compounds, one or more perester compounds, or any mixture thereof. In some embodiments, suitable azo compounds can be or can include, but are not limited to, 2,2′-azobis(2-amidinopropane) dihydrochloride, 2,2′-azobis [2-(2-imidazolin-2-yl)propane] dihydrochloride, 2,2′-azobis(isobutyronitrile) (AIBN), 2,2′-azobis(2,4-dimethylvaleronitrile) (AIVN), or any mixture thereof. Illustrative peroxides can be or can include, but are not limited to, ammonium persulfate, sodium persulfate, potassium persulfate, t-butyl peroxide, benzoyl peroxide, or any mixture thereof. In some embodiments, a molar ratio between the first monomer (hydrophobic cationic monomer) and the initiator can be about 1:0.1 or about 1:0.5 to about 1:2 or about 1:10.

In some embodiments, the first mixture can include about 0.05 mol %, about 0.1 mol %, about 0.5 mol %, or about 0.7 mol % to about 2 mol %, about 3 mol %, about 4 mol %, or about 5 mol % of the first monomer, about 45 mol %, about 50 mol %, about 55 mol %, or about 60 mol % to about 70 mol %, about 80 mol %, about 90 mol %, or about 98 mol % of the second monomer, about 2 mol %, about 5 mol %, about 10 mol %, or about 15 mol % to about 25 mol %, about 35 mol %, about 45 mol %, or about 50 mol % of the third monomer, based on a combined amount of the first monomer, the second monomer, and the third monomer. In some embodiments, the first mixture can include water in an amount of about 20 wt %, about 30 wt %, about 40 wt %, or about 50 wt % to about 60 wt %, about 70 wt %, about 80 wt %, or about 90 wt %, based on a combined weight of the first monomer, the second monomer, the third monomer, and the water.

In some embodiments, the prepolymer can have a theoretical concentration of about 10 wt % to about 70 wt % (e.g., about 10 wt % to about 60 wt %, about 10 wt % to about 50 wt %, about 10 wt % to about 40 wt %, about 20 wt % to about 60 wt %, about 20 wt % to about 50 wt %, about 20 wt % to about 30 wt %, about 30 wt % to about 60 wt %, about 30 wt % to about 50 wt %, or about 30 wt % to about 40 wt %) of actives. As used herein, the term “Actives” in the prepolymer represents the total weight as a percentage in a solution of all the monomers used for making such a polymer on dry basis.

The prepolymer and an aldehyde can be reacted to produce the strengthening resin. In some embodiments, the pH of the prepolymer can be adjusted to provide a pH of about 7.5 to about 12 or about 8 to about 9.5 by adding a base compound thereto. Illustrative base compounds can be or can include, but are not limited to, hydroxides, e.g., sodium hydroxide, carbonates, e.g., sodium carbonate, ammonia, amines, e.g., trimethylamine, or any mixture thereof.

The aldehyde, e.g., glyoxal, can be added to the prepolymer to produce a second reaction mixture and reacted therewith. In some embodiments, the pH of the second reaction mixture can be adjusted to provide a pH of about 7.5 to about 10 or about 8 to about 9 by adding a base compound thereto such as sodium hydroxide. In some embodiments, the second reaction mixture can react for about 10 minutes, about 20 minutes, about 30 minutes, or about an hour to about 6 hours, about 12 hours, about 24 hours, or about 30 hours to produce the strengthening resin.

In some embodiments, the second reaction mixture can be at a temperature of about 20° C. to about 50° C. until the polymer or strengthening resin has a desired viscosity. In some embodiments, the second reaction mixture can be reacted until a viscosity of the resin mixture is about 1 cP, about 2 cP, about 4 cP, or about 10 cP to about 50 cP, about 100 cP, about 150 cP, about 200 cP, or about 250 cP. The viscosity of the resin mixture can be measured with a Brookfield viscometer, e.g., Brookfield DV-E Viscometer, #61/62 spindle at 60 rpm. When the resin mixture has the desired viscosity, the pH of the resin mixture can be decreased to about 2 or about 2.5 to about 3.5 or 5 by adding an acid, e.g., sulfuric acid, thereto. The resin mixture can have a viscosity of about 3 cP, about 10 cP, about 25 cP, or about 50 cP to about 100 cP, about 125 cP, about 150 cP, about 175 cP, or about 200 cP at a temperature of about 25° C., as measured using a Brookfield DV-E Viscometer, spindle 61/62 at 60 rpm. In some embodiments, the resin can have a viscosity of less than 200 cP, less than 175 cP, less than 150 cP, less than 125 cP, less than 100 cP, less than 90 cP, or less than 75 cP and greater than 3 cP, greater than 10 cP, greater than 25 cP, or greater than 50 cP at a temperature of about 25° C., as measured using a Brookfield DV-E Viscometer, spindle 61/62 at 60 rpm. In some embodiments, the resin mixture can have a viscosity of less than 200 cP, less than 175 cP, less than 150 cP, less than 125 cP, less than 100 cP, less than 90 cP, or less than 75 cP and greater than 3 cP, greater than 10 cP, greater than 25 cP, or greater than 50 cP at a temperature of about 25° C. and a solids content of about 5 wt % to about 25 wt % based on a combined weight of the strengthening resin and water, as measured using a Brookfield DV-E Viscometer, spindle 61/62 at 60 rpm.

In some embodiments, the second reaction mixture can include about 50 wt %, about 55 wt %, about 60 wt %, or about 65 wt % to about 80 wt %, about 85 wt %, about 90 wt %, about 95 wt %, or about 98 wt % of the prepolymer and about 2 wt %, about 5 wt %, about 10 wt %, about 15 wt %, or about 20 wt % to about 35 wt %, about 40 wt %, about 45 wt %, or about 50 wt % of the aldehyde, based on a combined weight of the prepolymer and the aldehyde. The solids content of the resin mixture can be adjusted to any desired amount by adjusting the amount of solvent used during polymerization and/or by adding solvent to the strengthening resin and/or by removing solvent from the resin mixture. Synthesis of the strengthening resin can be carried out in a batch process, in a semi-batch process, or in a continuous process.

The strengthening resin can be used in the manufacture of fiber products, e.g., paper products. It has been surprisingly and unexpectedly discovered that the strengthening resin can be used to make a fiber product, e.g., a paper product, which can have a reduced dry strength and/or increased softness while maintaining a sufficient level of wet-strength. The strengthening resin can be mixed, blended, combined, or otherwise contacted with a plurality of fibers to produce a resinated furnish. In some embodiments, the plurality of fibers can be suspended or dispersed in water in the form of an aqueous slurry and the strengthening resin can be added thereto to produce the resinated furnish.

The aqueous slurry that includes the fibers can include about 0.01 wt % to about 10 wt % (e.g., about 0.01 wt % to about 8 wt %, about 0.01 wt % to about 6 wt %, about 0.01 wt % to about 4 wt %, about 0.5 wt % to about 10 wt %, about 0.5 wt % to about 8 wt %, about 0.5 wt % to about 6 wt %, about 0.5 wt % to about 4 wt %, about 1 wt % to about 10 wt %, about 1 wt % to about 8 wt %, about 1 wt % to about 6 wt %, about 1 wt % to about 4 wt %, about 2 wt % to about 10 wt %, about 2 wt % to about 8 wt %, about 2 wt % to about 6 wt %, or about 2 wt % to about 4 wt %) of the plurality of fibers, based on a combined weight of the plurality of fibers and water. The resinated furnish can include about 0.005 wt % to about 5 wt % (e.g., about 0.005 wt % to about 4 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 4 wt %, about 0.01 wt % to about 3 wt %, about 0.01 to about 2 wt %, about 0.01 wt % to about 1 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.5 wt % to about 5 wt %, about 0.5 wt % to about 4 wt %, about 1 wt % to about 5 wt %, about 1.5 wt % to about 5 wt %, about 2 wt % to about 5 wt %, or about 3 wt % to about 5 wt %) of the strengthening resin, based on a dry weight of the plurality of fibers.

In some embodiments, the fibers can be derived from bleached furnish, softwood, hardwood, paper pulp, mechanical pulp, or any mixture thereof. In some embodiments, the fibers can included nonwood fibers, such as cotton fibers or cotton derivatives, abaca, kenaf, sabai grass, flax, esparto grass, straw, jute, hemp, bagasse, milkweed floss fibers, and pineapple leaf fibers; and wood fibers such as those obtained from deciduous and coniferous trees, including softwood fibers, such as Northern and Southern softwood kraft fibers; hardwood fibers, such as maple, birch, aspen, or any mixture thereof. In some embodiments, the fibers can be or can include fibers recovered from previously manufactured fiber products. In other words, the fibers can be or can include recycled fibers. The fibers can be liberated from the source material by any of a number of well-known mechanical and/or chemical processes such as sulfate, sulfite, polysulfide, and/or soda pulping. The pulp can be bleached if desired by chemical means including the use of chlorine, chlorine dioxide, oxygen, ozone, hydrogen peroxide, alkaline metal peroxide, alkaline earth metal peroxides, as well as other compounds. In some embodiments, the plurality of fibers can be a mixture of softwood and hardwood fibers.

In some embodiments, the resinated furnish can be conditioned for a period of time, which can facilitate contact between the components. Conditioning can include, but is not limited to, agitating the resinated furnish for a period of time of about 30 seconds, about 1 minute, about 2 minutes, about 3 minutes or about 4 minutes to about 5 minutes, about 10 minutes, about 15 minutes, about 20 minutes, about 30 minutes, about 1 hour, or about 24 hours. In some embodiments, conditioning the mixture can also include heating (or cooling) the mixture to a temperature of about 1° C., about 20° C., or about 35° C. to about 60° C., about 80° C., or about 95° C.

Conditioning can also include adjusting a pH of the resinated furnish. The pH of the resinated furnish can be about 4, about 5, or about 6 to about 8, about 9, about 10, or 11, e.g., about 5 to about 9. Any one or combination of acid and/or base compounds can be combined with the resinated furnish to adjust the pH thereof. Illustrative acid compounds can be or can include, but are not limited to, one or more mineral acids, e.g., hydrochloric acid, one or more organic acids, e.g., acetic acid, one or more acid salts, e.g., ammonium sulfate, or any mixture thereof. Illustrative base compounds can be or can include, but are not limited to, hydroxides, e.g., sodium hydroxide, carbonates, e.g., sodium carbonate, ammonia, amines, e.g., trimethylamine, or any mixture thereof.

The resinated furnish can be formed into a fiber sheet such that the fiber sheet can include the fibers and the strengthening resin. In some embodiments, a slurry of paper making raw materials at a consistency in the range 0.1 wt % to 1.0 wt % can be dewatered to form a sheet with a final consistency of about 95 wt %. Paper machines, e.g., tissue machines, can accomplish the dewatering through a series of different processes that can include: 1) inertial dewatering (early forming section of the machine); 2) press dewatering (press section of the machine); and 3) thermally evaporating the water (dryer section of the machine). In some tissue machines, through-air drying cylinders can be located after the forming section and before the dryer section.

In some embodiments, the strengthened fiber product can have a basis weight of about 10 g/m², about 20 g/m², about 30 g/m², about 35 g/m², about 40 g/m², about 45 g/m², about 50 g/m², or about 55 g/m² to about 60 g/m², about 65 g/m², about 70 g/m², about 75 g/m², about 80 g/m², about 85 g/m², about 80 g/m², about 95 g/m², about 100 g/m², about 105 g/m², about 110 g/m², about 115 g/m², about 120 g/m², about 125 g/m², about 130 g/m², or greater.

In some embodiments, the strengthened fiber product can have a bulk of about 1 cm³/g, about 3 cm³/g, or about 4 cm³/g to about 8 cm³/g, about 10 cm³/g, or about 12 cm³/g. The bulk can be determined from the measured caliper (TAPPI test method T580 pm-12) to the basis weight (TAPPI test method T410 om-02).

In some embodiments, the strengthened fiber product can have a dry tensile strength index of about 5 Nm/g, about 7 Nm/g, about 9 Nm/g, about 11 Nm/g, about 13 Nm/g, or about 15 Nm/g to about 17 Nm/g, about 20 Nm/g, about 25 Nm/g, about 30 Nm/g, about 35 Nm/g, or about 40 Nm/g. In some embodiments, the strengthened fiber product can have a dry tensile strength index of <40 Nm/g, <35 Nm/g, <30 Nm/g, <25 Nm/g, <20 Nm/g, <17 Nm/g, <15 Nm/g, <13 Nm/g, or <10 Nm/g. The dry tensile strength index can be measured according to TAPPI test method T494 om-13.

In some embodiments, the strengthened fiber product can have a wet tensile strength index of about 0.1 Nm/g, about 0.3 Nm/g, about 0.5 Nm/g, about 1 Nm/g, about 1.5 Nm/g, or about 2 Nm/g to about 4 Nm/g, about 5 Nm/g, about 6 Nm/g, about 7 Nm/g, about 8 Nm/g, or about 9 Nm/g. In some embodiments, the strengthened fiber product can have a wet tensile strength index of at least 3 Nm/g, at least 3.3 Nm/g, at least 3.5 Nm/g, at least 3.7 Nm/g, or at least 4 Nm/g. The wet tensile strength index can be measured according to TAPPI test method T456 om-15.

In some embodiments, the strengthened fiber product can have a wet/dry tensile ratio of about 5%, about 7%, or about 10% to about 12%, about 15%, about 17%, about 20%, about 22%, or about 25%. The wet/dry tensile ratio is the ratio of the corresponding tensile indices multiplied by 100. In some embodiments, the strengthened fiber product can have a wet tensile decay ratio of <75%, <65%, <60%, <55%, <50%, <45%, <40%, <35%, <30%, <25%, or <20%. For the wet tensile decay, the 5-second wet tensile strength is complemented with a wet strength pull that starts five minutes after initially wetting the paper strip. The decay is defined as the ratio of the difference in wet tensile strength at five minutes and 5-seconds to the wet tensile strength at 5-seconds, which is multiplied by 100 to arrive at the percent value.

In some specific embodiments, a strengthened fiber product that includes about 0.05 wt % to about 0.4 wt % of strengthening resin solids, based on a dry weight of the plurality of fibers, having a basis weight of about 15 g/m² to about 30 g/m² and a density of about 0.05 g/cm³ to about 0.15 g/cm³ can have a dry tensile strength index of about 5 Nm/g to about 15 Nm/g, a wet tensile strength index of about 0.5 Nm/g to about 2 Nm/g, a wet/dry tensile ratio of about 5% to about 15%, and a wet tensile decay ratio of about 20% to about 60%.

### Examples

In order to provide a better understanding of the foregoing discussion, the following non-limiting examples are offered. Although the examples can be directed to specific embodiments, they are not to be viewed as limiting the invention in any specific respect. All parts, proportions, and percentages are by weight unless otherwise indicated.

### Preparation of Hydrophobic Monomer

To a 500-mL three-neck round bottom flask with a magnetic stir bar, about 39.41 g of N,N-dimethyl-n-octadecylamine (CAS No. 124-28-7), about 172.50 g of deionized water, about 0.0025 g of 4-methoxyphenol (MEHQ), and about 20.01 g of 3-/4-vinylbenzyl chloride (CAS No. 30030-25-2) were sequentially added with mixing between additions. The round bottom flask was equipped with a thermocouple and a condenser, and placed in an oil bath. The reaction mixture was heated from room temperature to a temperature of about 81° C., over a time period of about 15 minutes. When the reaction mixture reached a temperature of about 81° C., the reaction mixture was maintained at a temperature of about 81° C. to about 83° C. for a time period of about 20 min during which the reactants reacted to produce the hydrophobic monomer, i.e., N,N-Dimethyl-N-(3-/4-vinylbenzyl)stearylammonium chloride. The hydrophobic monomer was slowly cooled to room temperature while stirring. The hydrophobic monomer was analyzed by quantitative ¹H NMR in deuterated methanol with ethylene glycol as an internal standard. The resulting product was a 24.3% actives aqueous solution of the hydrophobic monomer (N,N-Dimethyl-N-(3-/4-vinylbenzyl)stearylammonium chloride) and had a purity of about 90.1%.

### Preparation of Prepolymer A:

To a 2-liter reaction flask equipped with a mechanical stirrer, thermocouple, condenser, nitrogen purge tube, and addition port, a solution that included about 181.95 g of deionized water, about 133.70 g of 62.24% diallyldimethylammonium chloride (DADMAC) (CAS No. 7398-69-8), about 7.60 g of sodium formate, about 0.092 g of ethylenediamine tetraacetic acid (EDTA), about 15.61 g of a 50% aqueous sodium hydroxide solution, and about 26.29 g of phosphoric acid was added. The reaction flask was purged with nitrogen and heated to reflux. Upon reaching the desired temperature, e.g., about 95° C. to about 100° C., about 17.62 g of a 25% aqueous solution of ammonium persulfate (APS) was added to the mixture over a time period of about 133 minutes. About two minutes after starting the addition of ammonium persulfate solution, a mixture that included about 522.71 g of a 51.03% acrylamide, about 25.07 g of deionized water, about 35.51 g of a 27.20% aqueous solution of the hydrophobic monomer (N,N-Dimethyl-N-(3-/4-vinylbenzyl)stearylammonium chloride), and about 31.28 g of cetrimonium bromide (CTAB) (CAS No. 57-09-0) (surfactant) were added to the reaction mixture over a period of about 123 minutes. An hour thereafter, the nitrogen purge tube was raised above the liquid level. The reaction was held at reflux for about another 60 minutes after the addition of the ammonium persulfate solution was completed to produce the prepolymer A. The prepolymer A was then cooled to room temperature. The prepolymer A had a theoretical concentration of about 36.05% of actives, based on total monomers used, and a weight average molecular weight (M_{w}) of about 20,000 g/mole.

### Preparation of Prepolymer B

To a 2-liter reaction flask equipped with a mechanical stirrer, thermocouple, condenser, nitrogen purge tube, and addition port, a solution that included about 143.69 g of deionized water, about 42.77 g of 62.24% diallyldimethylammonium chloride, and about 5.76 g of sodium formate was added. The reaction flask was purged with nitrogen and heated to a temperature of about 85° C. to about 90° C. Upon reaching the temperature of about 85° C. to about 90° C., the nitrogen purge was raised above the liquid level, and about 14.09 g of a 25% aqueous solution of ammonium persulfate (APS) was added to the mixture over a period of about 133 minutes. About two minutes after starting the addition of the ammonium persulfate solution, a nitrogen-purged monomer mixture that included about 414.67 g of 51.03% acrylamide, 64.17 g of 62.24% DADMAC, about 20.00 g of deionized water, about 67.82 g of 11.4% of an aqueous solution of the hydrophobic monomer (N,N-Dimethyl-N-(3-/4-vinylbenzyl)stearylammonium chloride), about 25.02 g of cetrimonium bromide (surfactant), about 2 g of sodium hypophosphite, and about 0.0737 g of ethylenediamine tetraacetic acid was added to the reaction mixture over a period of about 122 minutes. The reaction mixture was held at a temperature of about 90° C. for an additional hour after the addition of the ammonium persulfate solution was completed to produce the prepolymer B. The pre-polymer B was then cooled to room temperature. The pre-polymer B had a theoretical concentration of about 35.96% of actives and a weight average molecular weight of about 12,000 g/mole.

### Preparation of Strengthening Resins (Ex. 1 and Ex. 2)

The prepolymer A (about 82.3 g) prepared above and water (about 355 g) were charged into a 500 mL beaker at room temperature. The pH of the polymer solution was adjusted to about 8.8 to about 9.2 by adding about 1.8 g of a 50% aqueous sodium hydroxide solution. The reaction temperature was set to about 24° C. to about 26° C. Glyoxal (about 35.5 g of a 40% aqueous solution) (CAS No. 107-22-2) was added over approximately 15 minutes and the pH of the resulting mixture was adjusted to about 8.5 to about 8.8 by adding about 5.4 g of a 10% sodium hydroxide solution. The Brookfield viscosity (Brookfield DV-E Viscometer, #1 spindle @ 60 rpm, Brookfield Engineering Laboratories, Inc, Middleboro, Mass.) of the mixture was about 4 cP to about 6 cP after the addition of the sodium hydroxide solution. The pH of the reaction mixture was maintained at about 8 or above with good mixing. The Brookfield viscosity (BFV) was measured and monitored about every 10 minutes to 15 minutes and upon achieving the desired viscosity increase of greater than or equal to 1 cP, e.g., about 4 cP to about 200 cP, the pH of the reaction mixture was decreased to about 2.5 to about 3.5 by adding sulfuric acid (93%). The rate of viscosity increase was found to be dependent on the reaction pH. The higher the pH of the reaction, the faster the rate of viscosity increase. The strengthening resins were a clear to hazy, colorless to amber fluid with a Brookfield viscosity of greater than or equal to 5 cP. The strengthening resins had a prepolymer molar ratio of the hydrophobic monomer to diallyldimethylammonium chloride to acrylamide of about 0.5/12/87.5 and a glyoxal to acrylamide molar ratio of about 0.8. The Ex. 1 and Ex. 2 strengthening resins had a Brookfield viscosity of about 13.6 cP and about 28 cP, respectively, and a theoretical concentration of about 8.96% of actives (total glyoxal and pre-polymer A).

### Preparation of Strengthening Resins (Ex. 3 and Ex. 4)

Ex. 3 and Ex. 4 strengthening resins were prepared following a procedure similar to the procedure used to make the Ex. 1 and Ex. 2 strengthening resins, except that prepolymer B was used. Ex. 3 and Ex. 4 had a Brookfield viscosity of about 13.5 and about 9.1 cP, respectively, and a theoretical concentration of about 8.96% of actives (total glyoxal and pre-polymer B).

### Evaluation of Strengthening Resins

The Ex. 1-4 strengthening resins were evaluated. In all studies, sheets were made with a 35/65 softwood kraft/hardwood kraft blend prepared from dry lap. The studies consistently included conditions with a control glyoxalated polyacrylamide-based strength aid (“control”) containing no hydrophobic moieties, as a reference. The control glyoxalated polyacrylamide-based strength aid was a glyoxalated acrylamide/DADMAC copolymer and is commercially available from Nalco Water, an Ecolab company, under the name Nalco 63403.

The furnish composition was a 35/65 softwood kraft/hardwood kraft blend prepared from dry lap. No pulp refining took place. The sheet basis weight was approximately 60 g/m². The thin stock for a set of five handsheets per condition was mixed with a propeller at 1,000 rpm, where the desired amount of the strength aid was added and allowed to mix for at least 45 seconds. After mixing, each sheet was formed in a Noble & Wood handsheet mold using a 100-mesh screen. Once formed, the sheet was couched using two blotters and six passes of a 25-pound roll followed by the removal of one of the wet blotters, pressed in a single pass through a roll press with four new blotters, and dried in a drum dryer at about 105° C. for one minute without blotters.

The Ex. 1-4 strengthening resins were evaluated by measuring both dry tensile strength and wet tensile strength of the handsheets. Wet tensile strength was conducted five seconds after initially wetting the paper strip. The wet/dry ratio is the ratio of the corresponding tensile indices multiplied by 100. For the wet tensile decay, the 5-second wet tensile strength is complemented with a wet strength pull that starts five minutes after initially wetting the paper strip. The decay is defined as the ratio of the difference in wet tensile strengths at 5 minutes and 5 seconds to the wet tensile at 5 seconds. To express it as a percentage, the ratio is multiplied by 100. Chemical dosages are expressed as the ratio of kilograms of actives per tonne of dry paper (kg/t), where one tonne is equivalent to 1,000 kilograms. The strengthening resins were evaluated according to the following standardized test procedures: TAPPI test method T402 sp-13 for sheet conditioning, TAPPI test method T494 om-13 for dry tensile, and TAPPI test method T456 om-15 for wet tensile. The results for Ex. 1 and Ex. 2 are shown in Table 1 below.

TABLE 1

| | | | | Dry tensile | Wet tensile | | Wet |
|---|---|---|---|---|---|---|---|
| | | Basis | | strength | strength | Wet/dry | tensile |
| | | weight, | Bulk, | index, | index, | tensile | decay |
| Example | kg_{actives}/t | g/m² | cm³/g | Nm/g | Nm/g | ratio, % | ratio, % |
| — | 0 | 59.9 | 2.12 | 15 | 0.18 | 1.2 | — |
| Control | 1 | 59.1 | 2.14 | 21 | 1.75 | 8.51 | 67 |
| Ex. 1 | 1 | 61.8 | 2.14 | 20 | 1.44 | 7.16 | 70 |
| Ex. 2 | 1 | 61.2 | 2.15 | 21 | 1.57 | 7.45 | 53 |
| Control | 2 | 60.1 | 2.16 | 24 | 3.00 | 12.45 | 62 |
| Ex. 1 | 2 | 62.9 | 2.13 | 23 | 2.69 | 11.62 | 64 |
| Ex. 2 | 2 | 59.9 | 2.16 | 24 | 3.04 | 12.72 | 34 |
| Control | 4 | 61.5 | 2.15 | 31 | 4.64 | 15.21 | 52 |
| Ex. 1 | 4 | 57.4 | 2.18 | 29 | 4.42 | 15.50 | 61 |
| Ex. 2 | 4 | 60.1 | 2.23 | 27 | 4.53 | 17.10 | 29 |

Table 1 above shows that wet strength increased with increasing dose equally for all products in the range of 0-4 kg/t. However, the dry strength of Ex. 2 was about 13% unexpectedly lower than the control resin at the high dose of 4 kg/t, which also correlates with an unexpected 4% difference in sheet bulk at the high dose. This new dry strength difference at the high dose also resulted in a greater wet/dry tensile ratio for the Ex. 2 resin. The wet tensile decay was markedly lower for Ex. 2 in the 1-4 kg/t dose range.

Motivated by the unexpected performance difference at the highest dose of 4 kg/t in the previous study, a new handsheet study was conducted to look at the performance of the Ex. 2 resin in a dose amount that was twice as large. The results for the additional evaluations of the Ex. 2 resin are shown in Table 2 below.

TABLE 2

| | | | | Dry tensile | Wet tensile | | Wet |
|---|---|---|---|---|---|---|---|
| | | Basis | | strength | strength | Wet/dry | tensile |
| | | weight, | Bulk, | index, | index, | tensile | decay |
| Example | kg_{actives}/t | g/m² | cm³/g | Nm/g | Nm/g | ratio, % | ratio, % |
| — | 0 | 65 | 2.16 | 14.4 | 0.1 | 0.8 | — |
| Control | 1 | 60 | 2.22 | 18.1 | 1.3 | 7.4 | 43.5 |
| Ex. 2 | 1 | 63 | 2.17 | 15.9 | 1.3 | 8.1 | 33.0 |
| Control | 4 | 59 | 2.28 | 27.4 | 3.8 | 14.1 | 26.3 |
| Ex. 2 | 4 | 62 | 2.24 | 19.8 | 3.8 | 20.1 | 30.3 |
| Control | 8 | 65 | 2.21 | 32.2 | 5.0 | 15.6 | 23.0 |
| Ex. 2 | 8 | 67 | 2.18 | 27.3 | 4.7 | 17.5 | 15.1 |
| Control | 16 | 67 | 2.22 | 30.7 | 5.5 | 18.1 | 25.9 |
| Ex. 2 | 16 | 62 | 2.21 | 28.9 | 5.0 | 17.7 | 17.0 |

Table 2 shows that the Ex. 2 resin resulted in lower dry tensile strength in the intermediate dosages of 4 and 8 kg/t and lower wet tensile strength at the high dose of 16 kg/t relative to the control resin. The wet/dry ratio is higher at the intermediate dosages and only statistically different at 4 kg/t. The wet tensile decay cannot be statistically differentiated from the control resin.

The results for the Ex. 3 and Ex. 4 resins are shown in Table 3 below.

TABLE 3

| | | | | Dry tensile | Wet tensile | | Wet |
|---|---|---|---|---|---|---|---|
| | | Basis | | strength | strength | Wet/dry | tensile |
| | | weight, | Bulk, | index, | index, | tensile | decay |
| Example | kg_{actives}/t | g/m² | cm³/g | Nm/g | Nm/g | ratio, % | ratio, % |
| — | 0 | 67 | 2.16 | 18 | 0.2 | 1.4 | — |
| Control | 1 | 70 | 2.17 | 19 | 1.3 | 6.5 | 37 |
| Ex. 3 | 1 | 66 | 2.27 | 21 | 1.5 | 7.1 | 33 |
| Ex. 4 | 1 | 66 | 2.21 | 21 | 1.7 | 8.0 | 38 |
| Control | 4 | 67 | 2.31 | 26 | 3.5 | 13.3 | 29 |
| Ex. 3 | 4 | 69 | 2.21 | 26 | 3.7 | 14.3 | 28 |
| Ex. 4 | 4 | 59 | 2.24 | 29 | 4.5 | 15.8 | 30 |
| Control | 8 | 63 | 2.29 | 32 | 5.4 | 16.9 | 28 |
| Ex. 3 | 8 | 68 | 2.24 | 29 | 4.9 | 16.7 | 25 |
| Ex. 4 | 8 | 67 | 2.25 | 30 | 5.1 | 17.1 | 28 |
| Control | 16 | 63 | 2.21 | 36 | 6.3 | 17.6 | 22 |
| Ex. 3 | 16 | 64 | 2.23 | 29 | 4.9 | 16.9 | 26 |
| Ex. 4 | 16 | 61 | 2.20 | 29 | 5.1 | 17.7 | 28 |

Table 3 shows that the Ex. 4 resin outperformed the reference Nalco 63403 resin in both dry and wet strength at 4 kg/t. However, both the Ex. 3 and the Ex. 4 resin resulted in lower dry and wet tensile strength by up to 20% relative to the reference Nalco 63403 resin at the two high dosages of 8 kg/t and 16 kg/t. Both forms of strength unexpectedly changed with the dose and resulted in no significant difference in the wet/dry ratio with respect to the reference Nalco 63403 resin through the dose range of 0-16 kg/t. Similarly, the wet tensile strength decay remained undifferentiated with respect to the control resin.

Embodiments of the present disclosure further relate to any one or more of the following paragraphs:

A resin mixture comprising a solvent and a strengthening resin, wherein the strengthening resin has a chemical formula of (I), wherein the chemical formula (I) comprises:

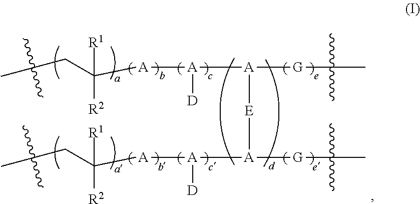

wherein:
each A repeating unit is derived from a monomer comprising an aldehyde-reactive moiety, each A-D moiety is derived from a reaction between an A repeating unit and an aldehyde, each A-E-A moiety is derived from a reaction between two A repeating units and an aldehyde, each G repeating unit is derived from a monomer that is free of an aldehyde reactive moiety comprising N,N-dimethylacrylamide, N,N-diethylacrylamide, N-isopropylacrylamide, N-isopropylmethacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, vinyl acetate, vinyl alcohol, acrylic acid, a salt of acrylic acid, methacrylic acid, a salt of methacrylic acid, 2-acrylamido-2-methylpropanesulfonic acid, a sodium salt of 2-acrylamido-2-methylpropanesulfonic acid, sodium vinyl sulfonate, styrene sulfonate, maleic acid, a salt of maleic acid, sulfonate, itaconate, sulfopropyl acrylate, sulfopropyl methacrylate, a monoallyl amine, a diallyl amine, a vinyl amine, a dialkylaminoalkyl acrylate, a quaternary dialkylaminoalkyl acrylate, a salt of a dialkylaminoalkyl acrylate, a dialkylaminoalkyl methacrylate, a quaternary dialkylaminoalkyl methacrylate, a salt of a dialkylaminoalkyl methacrylate, a dialkylaminoalkylacrylamide, a quaternary dialkylaminoalkylacrylamide, a salt of a dialkylaminoalkylacrylamide, a dialkylaminoalkyl methacrylamide, a quaternary dialkylaminoalkyl methacrylamide, a salt of a dialkylaminoalkyl methacrylamide, a diallyldiethylammonium chloride, a diallyldimethyl ammonium chloride, N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine, 2-[(3-acrylamidopropyl)dimethylammonio] ethyl 2′-isopropyl phosphate, 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl) ammonium betaine, or a mixture thereof, the total mol % of a and a′ is equal to about 0.05 mol % to about 5 mol %, the total mol % of b and b′ is equal to about 30 mol % to about 90 mol %, the total mol % of c and c′ is equal to about 4 mol % to about 40 mol %, the total mol % of d is equal to about 2 mol % to about 20 mol %, and the total mol % of e and e′ is equal to 2 mol % to about 50 mol %, wherein all mol % values are based on a combined amount of each a, each a′, each b, each b′, each c, each c′, each d, each e, and each e′, each R¹ is a hydrogen atom, a methyl group, or an ethyl group, each R² is derived from a hydrophobic cationic monomer having a chemical formula of (II), (III), or (IV), wherein: the chemical formula (II) comprises:

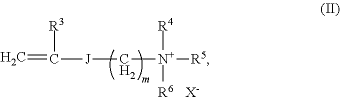

the chemical formula (III) comprises:

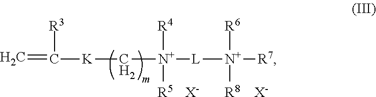

and the chemical formula (IV) comprises:

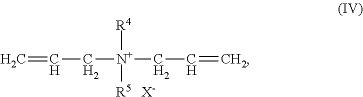

wherein: R³ is a hydrogen atom, a methyl group, or an ethyl group, J and K are independently —CH₂—, —O—, —C(O)O—, —C(O)NH—, or arylene, R⁴, R⁵, R⁶, R⁷ and R⁸ are independently a hydrogen atom, a linear or branched C1-C30 alkyl group, a linear or branched C1-C30 hydroxyalkyl group, or a linear or branched C1-C30 aminoalkyl group, m and n are independently an integer of 0 to 6, L is a linear or branched C2-C12 hydrocarbon chain, and X⁻ is independently a counter ion selected from the group consisting of: chloride, bromide, iodide, hydroxide, phosphate, sulfate, hydrosulfate, ethyl sulfate, methyl sulfate, formate, and acetate.

2. The resin mixture of paragraph 1, wherein the solvent is selected from the group consisting of: water, methanol, ethanol, acetonitrile, and a mixture thereof.

3. The resin mixture of paragraph 1 or 2, wherein the resin mixture comprises about 3 wt % to about 30 wt % of the strengthening resin based on a combined weight of the solvent and the strengthening resin.

4. The resin mixture of any of paragraphs 1 to 3, wherein: the total mol % of a and a′ is equal to about 0.1 mol % to about 2 mol %, the total mol % of b and b′ is equal to about 50 mol % to about 80 mol %, the total mol % of c and c′ is equal to about 10 mol % to about 30 mol %, the total mol % of d is equal to about 3 mol % to about 12 mol %, the total mol % of e and e′ is equal to 5 mol % to about 25 mol %, all mol % values are based on the combined amount of each a, each a′, each b, each b′, each c, each c′, each d, each e, and each e′.

5. The resin mixture of any of paragraphs 1 to 4, wherein the aldehyde comprises formaldehyde, paraformaldehyde, glutaraldehyde, glyoxal, malondialdehyde, succindialdehyde, or a mixture thereof.

6. The resin mixture of any of paragraphs 1 to 5, wherein each G is derived from diallyldimethyl ammonium chloride, acrylic acid, methacrylic acid, 2-dimethylaminoethyl acrylate methyl chloride quaternary salt, 2-dimethylaminoethyl methacrylate methyl chloride quaternary salt, or a mixture thereof.

7. The resin mixture of any of paragraphs 1 to 6, wherein: each A repeating unit is derived from acrylamide, methacrylamide, or acrylamide and methacrylamide, each A-D moiety is derived from a reaction between an A repeating unit and an aldehyde comprising glyoxal, each A-E-A moiety is derived from a reaction between two A repeating units and glyoxal, and G repeating unit is derived from diallyldimethyl ammonium chloride.

8. The resin mixture of any of paragraphs 1 to 7, wherein at least one R² is derived from a hydrophobic cationic monomer having the chemical formula of (II), and wherein: R³ is a hydrogen atom, J is phenylene, two of R⁴, R⁵, and R⁶ are a methyl group, one of R⁴, R⁵, and R⁶ is a linear C18 alkyl group, m is equal to 1, and X⁻ is a counter ion selected from the group consisting of: chloride, bromide, iodide, hydroxide, phosphate, sulfate, hydrosulfate, ethyl sulfate, methyl sulfate, formate, and acetate.

9. The resin mixture of any of paragraphs 1 to 8, wherein at least one R² is derived from a hydrophobic cationic monomer having the chemical formula of (III), and wherein: R³ is a methyl group, K is —C(O)NH—, n is equal to 3, R⁴ is a methyl group, R⁵ is a methyl group, L is —CH₂—CH(OH)—CH₂—, two of R⁶, R⁷, and R⁸ are a methyl group, one of R⁶, R⁷, and R⁸ is a linear C18 alkyl group, and X⁻ is a counter ion selected from the group consisting of: chloride, bromide, iodide, hydroxide, phosphate, sulfate, hydrosulfate, ethyl sulfate, methyl sulfate, formate, and acetate.

10. The resin mixture of any of paragraphs 1 to 9, wherein at least one R² is derived from a hydrophobic cationic monomer having the chemical formula of (IV), and wherein: R⁴ is a linear C12 alkyl group, R⁵ is a linear C12 alkyl group, and X⁻ is a counter ion selected from the group consisting of: chloride, bromide, iodide, hydroxide, phosphate, sulfate, hydrosulfate, ethyl sulfate, methyl sulfate, formate, and acetate.

11. The resin mixture of any of paragraphs 1 to 10, wherein L comprises one or more heteroatoms, one or more heterogroups, or a combination thereof.

12. The resin mixture of paragraph 11, wherein the one or more heteroatoms comprises 0, and wherein the one or more heterogroups comprises NH.

13. The resin mixture of any of paragraphs 1 to 12, wherein L is substituted with one or more hydroxy groups, one or more amino groups, or a combination thereof.

14. The resin mixture of any of paragraphs 1 to 13, wherein the solvent is water and the resin mixture comprises about 5 wt % to about 25 wt % of the strengthening resin, based on a combined weight of the strengthening resin and water.

15. The resin mixture of paragraph 14, wherein the resin mixture has a viscosity of about 3 cP to about 200 cP at a temperature of about 25° C., as measured using a Brookfield DV-E Viscometer, spindle 61/62 at 60 rpm.

16. The resin mixture of any of paragraphs 1 to 15, wherein the strengthening resin has a weight average molecular weight of about 50 kDa to about 5,000 kDa.

17. The resin mixture of any of paragraphs 1 to 16, wherein each A repeating unit is derived from acrylamide, methacrylamide, or a mixture thereof.

18. A process for making a paper product, comprising: adding a resin mixture to a slurry comprising a plurality of fibers and water to produce a resinated furnish; forming the resinated furnish into a wet paper web; pressing and draining the wet paper web to produce a wet paper sheet; and drying the wet paper sheet to produce a paper product, wherein the resin mixture comprises a solvent and a strengthening resin, and wherein the strengthening resin has a chemical formula of (I), wherein the chemical formula (I) comprises:

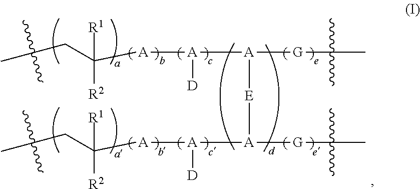

wherein: each A repeating unit is derived from a monomer comprising an aldehyde-reactive moiety, each A-D moiety is derived from a reaction between an A repeating unit and an aldehyde, each A-E-A moiety is derived from a reaction between two A repeating units and an aldehyde, each G repeating unit is derived from a monomer that is free of an aldehyde reactive moiety comprising N,N-dimethylacrylamide, N,N-diethylacrylamide, N-isopropylacrylamide, N-isopropylmethacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, vinyl acetate, vinyl alcohol, acrylic acid, a salt of acrylic acid, methacrylic acid, a salt of methacrylic acid, 2-acrylamido-2-methylpropanesulfonic acid, a sodium salt of 2-acrylamido-2-methylpropanesulfonic acid, sodium vinyl sulfonate, styrene sulfonate, maleic acid, a salt of maleic acid, sulfonate, itaconate, sulfopropyl acrylate, sulfopropyl methacrylate, monoallyl amine, diallyl amine, vinyl amine, dialkylaminoalkyl acrylates, a quaternary dialkylaminoalkyl acrylates, a salt of dialkylaminoalkyl acrylates, dialkylaminoalkyl methacrylates, a quaternary dialkylaminoalkyl methacrylates, a salt of dialkylaminoalkyl methacrylates, dialkylaminoalkylacrylamides, a quaternary dialkylaminoalkylacrylamides, a salt of dialkylaminoalkylacrylamides, dialkylaminoalkyl methacrylamides, a quaternary dialkylaminoalkyl methacrylamides, a salt of dialkylaminoalkyl methacrylamides, diallyldiethylammonium chloride, diallyldimethyl ammonium chloride, N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl) ammonium betaine, or a mixture thereof, the total mol % of a and a′ is equal to about 0.05 mol % to about 5 mol %, the total mol % of b and b′ is equal to about 30 mol % to about 90 mol %, the total mol % of c and c′ is equal to about 4 mol % to about 40 mol %, the total mol % of d is equal to about 2 mol % to about 20 mol %, and the total mol % of e and e′ is equal to 2 mol % to about 50 mol %, wherein all mol % values are based on a combined amount of each a, each a′, each b, each b′, each c, each c′, each d, each e, and each e′, each R¹ is a hydrogen atom, a methyl group, or an ethyl group, each R² is derived from a hydrophobic cationic monomer having a chemical formula of (II), (III), or (IV), wherein: the chemical formula (II) comprises:

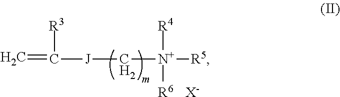

the chemical formula (III) comprises:

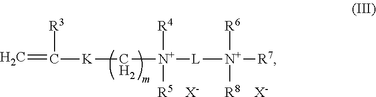

and the chemical formula (IV) comprises:

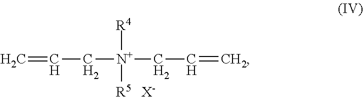

wherein: R³ is a hydrogen atom, a methyl group, or an ethyl group, J and K are independently —CH₂—, —O—, —C(O)O—, —C(O)NH—, or arylene, R⁴, R⁵, R⁶, R⁷ and R⁸ are independently a hydrogen atom, a linear or branched C1-C30 alkyl group, a linear or branched C1-C30 hydroxyalkyl group, or a linear or branched C1-C30 aminoalkyl group, m and n are independently an integer of 0 to 6, L is a linear or branched C2-C12 hydrocarbon chain, and X⁻ is independently a counter ion selected from the group consisting of: chloride, bromide, iodide, hydroxide, phosphate, sulfate, hydrosulfate, ethyl sulfate, methyl sulfate, formate, and acetate.

19. The process of paragraph 18, wherein the solvent is selected from the group consisting of: water, methanol, ethanol, acetonitrile, and a mixture thereof.

20. The process of paragraph 18 or 19, wherein the resin mixture comprises about 3 wt % to about 30 wt % of the strengthening resin based on a combined weight of the solvent and the strengthening resin.

21. The process of any of paragraphs 18 to 20, wherein the slurry comprises about 0.01 wt % to about 10 wt % of the plurality of fibers, based on a combined weight of the plurality of fibers and water.

22. The process of any of paragraphs 18 to 21, wherein the resinated furnish comprises about 0.005 wt % to about 5 wt % of the strengthening resin, based on a dry weight of the plurality of fibers.

23. The process of any of paragraphs 18 to 22, wherein L comprises one or more heteroatoms, one or more heterogroups, or a combination thereof.

24. The process of paragraph 23, wherein the one or more heteroatoms comprises 0, and wherein the one or more heterogroups comprises NH.

25. The process of any of paragraphs 18 to 24, wherein L is substituted with one or more hydroxy groups, one or more amino groups, or a combination thereof.

26. A process for making a strengthening resin, comprising: reacting a first mixture comprising a first monomer, a second monomer, and a third monomer to produce a prepolymer, wherein: the first monomer comprises a hydrophobic cationic monomer having a chemical formula of (II), (III), or (IV), wherein: the chemical formula (II) comprises:

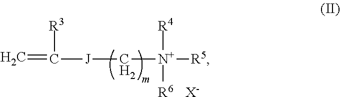

the chemical formula (III) comprises:

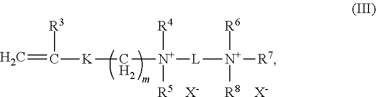

and the chemical formula (IV) comprises:

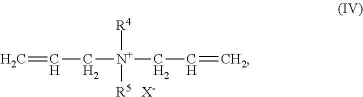

wherein: R³ is a hydrogen atom, a methyl group, or an ethyl group, J and K are independently —CH₂—, —O—, —C(O)O—, —C(O)NH—, or arylene, R⁴, R⁵, R⁶, R⁷ and R⁸ are independently a hydrogen atom, a linear or branched C1-C30 alkyl group, a linear or branched C1-C30 hydroxyalkyl group, or a linear or branched C1-C30 aminoalkyl group, m and n are independently an integer of 0 to 6, L is a linear or branched C2-C12 hydrocarbon chain, and X⁻ is independently a counter ion selected from the group consisting of: chloride, bromide, iodide, hydroxide, phosphate, sulfate, hydrosulfate, ethyl sulfate, methyl sulfate, formate, and acetate, the second monomer comprises acrylamide, methacrylamide, or a mixture thereof, and the third monomer has a different chemical structure with respect to the first monomer and the second monomer, wherein the third monomer is hydrophilic or hydrophobic, and wherein the third monomer is a cationic monomer, an anionic monomer, a zwitterionic monomer, a nonionic monomer, or a mixture thereof; and reacting a second mixture comprising the prepolymer and an aldehyde to produce the strengthening resin, wherein the aldehyde comprises formaldehyde, paraformaldehyde, glutaraldehyde, glyoxal, malondialdehyde, succindialdehyde, or a mixture thereof.

27. The process of paragraph 26, wherein the first monomer has the chemical formula (II), and wherein: R³ is a hydrogen atom, J is phenylene, two of R⁴, R⁵, and R⁶ are a methyl group, one of R⁴, R⁵, and R⁶ is a linear C18 alkyl group, m is equal to 1, and X⁻ is a counter ion selected from the group consisting of: chloride, bromide, iodide, hydroxide, phosphate, sulfate, hydrosulfate, ethyl sulfate, methyl sulfate, formate, and acetate.

28. The process of paragraph 26 or 27, wherein the first mixture comprises about 0.05 mol % to about 5 mol % of the first monomer, about 45 mol % to about 98 mol % of the second monomer, about 2 mol % to about 50 mol % of the third monomer, based on a combined amount of the first monomer, the second monomer, and the third monomer, and wherein the second mixture comprises about 50 wt % to about 98 wt % of the prepolymer and about 2 wt % to about 50 wt % of the aldehyde, based on a combined weight of the prepolymer and the aldehyde.

2930. The process of any of paragraphs 26 to 28, wherein the third monomer comprises a monoallyl amine, a diallyl amine, a vinyl amine, a dialkylaminoalkyl acrylate, a quaternary dialkylaminoalkyl acrylate, a salt of a dialkylaminoalkyl acrylate, a dialkylaminoalkyl methacrylate, a quaternary dialkylaminoalkyl methacrylate, a salt of a dialkylaminoalkyl methacrylate, a dialkylaminoalkylacrylamide, a quaternary dialkylaminoalkylacrylamide, a salt of a dialkylaminoalkylacrylamide, a dialkylaminoalkyl methacrylamide, a quaternary dialkylaminoalkyl methacrylamide, a salt of a dialkylaminoalkyl methacrylamide, diallyldiethylammonium chloride, diallyldimethyl ammonium chloride, or a mixture thereof.

30. The process of any of paragraphs 26 to 29, wherein the third monomer comprises acrylic acid, a salt of acrylic acid, methacrylic acid, a salt of methacrylic acid, 2-acrylamido-2-methylpropanesulfonic acid, a sodium salt of 2-acrylamido-2-methylpropanesulfonic acid, sodium vinyl sulfonate, styrene sulfonate, maleic acid, a salt of maleic acid, a sulfopropyl acrylate, a sulfopropyl methacrylate, a sulfomethylated acrylamide, an allyl sulfonate, itaconic acid, acrylamidomethylbutanoic acid, fumaric acid, vinylphosphonic acid, vinylsulfonic acid, allylphosphonic acid, phosphonomethylated acrylamide, itaconic anhydride, or a mixture thereof.

31. The process of any of paragraphs 26 to 30, wherein the third monomer comprises N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl) ammonium betaine, or a mixture thereof.

32. The process of any of paragraphs 26 to 31, wherein the third monomer comprises N,N-dimethylacrylamide, N,N-diethylacrylamide, N-isopropylacrylamide, N-isopropylmethacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, vinyl acetate, vinyl alcohol, or a mixture thereof.

33. The process of any of paragraphs 26 to 32, wherein the linear or branched C2-C12 hydrocarbon chain comprises one or more heteroatoms, one or more heterogroups, or a combination thereof.

34. The process of paragraph 33, wherein the one or more heteroatoms comprises 0, and wherein the one or more heterogroups comprises NH.

35. The process of any of paragraphs 26 to 34, wherein the linear or branched C2-C12 hydrocarbon chain is substituted with one or more hydroxy groups, one or more amino groups, or a combination thereof.

36. The process of any of paragraphs 26 to 34, wherein the first mixture further comprises a solvent selected from the group consisting of: water, methanol, ethanol, acetonitrile, and a mixture thereof.

37. The process of paragraph 36, wherein the second mixture comprises the solvent.

38. The process of paragraph 37, wherein a resin mixture comprising the solvent and the strengthening resin comprises about 3 wt % to about 30 wt % of the strengthening resin based on a combined weight of the solvent and the strengthening resin.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A resin mixture comprising a solvent and a strengthening resin,
wherein the solvent is selected from the group consisting of: water, methanol, ethanol, acetonitrile, and a mixture thereof,
wherein the strengthening resin has a chemical formula of (I), wherein the chemical formula (I) comprises: 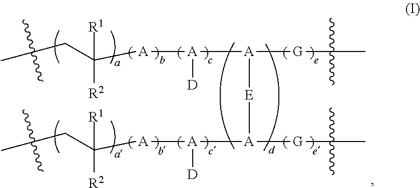
wherein:
each A repeating unit is derived from a monomer comprising an aldehyde-reactive moiety,
each A-D moiety is derived from a reaction between an A repeating unit and an aldehyde,
each A-E-A moiety is derived from a reaction between two A repeating units and an aldehyde,
each G repeating unit is derived from a monomer that is free of an aldehyde reactive moiety comprising N,N-dimethylacrylamide, N,N-diethylacrylamide, N-isopropylacrylamide, N-isopropylmethacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, vinyl acetate, vinyl alcohol, acrylic acid, a salt of acrylic acid, methacrylic acid, a salt of methacrylic acid, 2-acrylamido-2-methylpropanesulfonic acid, a sodium salt of 2-acrylamido-2-methylpropanesulfonic acid, sodium vinyl sulfonate, styrene sulfonate, maleic acid, a salt of maleic acid, sulfonate, itaconate, sulfopropyl acrylate, sulfopropyl methacrylate, a monoallyl amine, a diallyl amine, a vinyl amine, a dialkylaminoalkyl acrylate, a quaternary dialkylaminoalkyl acrylate, a salt of a dialkylaminoalkyl acrylate, a dialkylaminoalkyl methacrylate, a quaternary dialkylaminoalkyl methacrylate, a salt of a dialkylaminoalkyl methacrylate, a dialkylaminoalkylacrylamide, a quaternary dialkylaminoalkylacrylamide, a salt of a dialkylaminoalkylacrylamide, a dialkylaminoalkyl methacrylamide, a quaternary dialkylaminoalkyl methacrylamide, a salt of a dialkylaminoalkyl methacrylamide, a diallyldiethylammonium chloride, a diallyldimethyl ammonium chloride, N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine, 2-[(3-acrylamidopropyl)dimethylammonio]ethyl 2′-isopropyl phosphate, 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine, N,N-diallyl-N-methyl-N-(2-sulfoethyl) ammonium betaine, or a mixture thereof,
the total mol % of a and a′ is equal to about 0.05 mol % to about 5 mol %,
the total mol % of b and b′ is equal to about 30 mol % to about 90 mol %,
the total mol % of c and c′ is equal to about 4 mol % to about 40 mol %,
the total mol % of d is equal to about 2 mol % to about 20 mol %, and
the total mol % of e and e′ is equal to 2 mol % to about 50 mol %, wherein all mol % values are based on a combined amount of each a, each a′, each b, each b′, each c, each c′, each d, each e, and each e′,
each R¹ is a hydrogen atom, a methyl group, or an ethyl group,
each R² is derived from a hydrophobic cationic monomer having a chemical formula of (II), (III), or (IV), wherein:
the chemical formula (II) comprises: 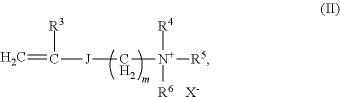
the chemical formula (III) comprises: 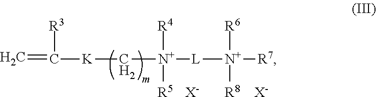
and
the chemical formula (IV) comprises: 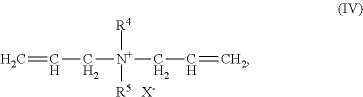
wherein:
R³ is a hydrogen atom, a methyl group, or an ethyl group,
J and K are independently —CH₂—, —O—, —C(O)O—, —C(O)NH—, or arylene,
R⁴, R⁵, R⁶, R⁷ and R⁸ are independently a hydrogen atom, a linear or branched C1-C30 alkyl group, a linear or branched C1-C30 hydroxyalkyl group, or a linear or branched C1-C30 aminoalkyl group,
m and n are independently an integer of 0 to 6,
L is a linear or branched C2-C12 hydrocarbon chain, and
X⁻ is independently a counter ion selected from the group consisting of: chloride, bromide, iodide, hydroxide, phosphate, sulfate, hydrosulfate, ethyl sulfate, methyl sulfate, formate, and acetate.

2. The resin mixture of claim 1, wherein the solvent comprises water.

3. The resin mixture of claim 1, wherein the resin mixture comprises about 3 wt % to about 30 wt % of the strengthening resin based on a combined weight of the solvent and the strengthening resin.

4. The resin mixture of claim 1, wherein:
the total mol % of a and a′ is equal to about 0.1 mol % to about 2 mol %,
the total mol % of b and b′ is equal to about 50 mol % to about 80 mol %,
the total mol % of c and c′ is equal to about 10 mol % to about 30 mol %,
the total mol % of d is equal to about 3 mol % to about 12 mol %,
the total mol % of e and e′ is equal to 5 mol % to about 25 mol %, and
all mol % values are based on the combined amount of each a, each a′, each b, each b′, each c, each c′, each d, each e, and each e′.

5. The resin mixture of claim 1, wherein the aldehyde comprises formaldehyde, paraformaldehyde, glutaraldehyde, glyoxal, malondialdehyde, succindialdehyde, or a mixture thereof.

6. The resin mixture of claim 1, wherein each G is derived from diallyldimethyl ammonium chloride, acrylic acid, methacrylic acid, 2-dimethylaminoethyl acrylate methyl chloride quaternary salt, 2-dimethylaminoethyl methacrylate methyl chloride quaternary salt, or a mixture thereof.

7. The resin mixture of claim 1, wherein:
each A repeating unit is derived from acrylamide, methacrylamide, or acrylamide and methacrylamide,
each A-D moiety is derived from a reaction between an A repeating unit and an aldehyde comprising glyoxal,
each A-E-A moiety is derived from a reaction between two A repeating units and glyoxal, and
each G repeating unit is derived from diallyldimethyl ammonium chloride.

8. The resin mixture of claim 1, wherein at least one R² is derived from a hydrophobic cationic monomer having the chemical formula of (II), and wherein:
R³ is a hydrogen atom,
J is phenylene,
two of R⁴, R⁵, and R⁶ are a methyl group,
one of R⁴, R⁵, and R⁶ is a linear C18 alkyl group,
m is equal to 1, and
X⁻ is a counter ion selected from the group consisting of: chloride, bromide, iodide, hydroxide, phosphate, sulfate, hydrosulfate, ethyl sulfate, methyl sulfate, formate, and acetate.

9. The resin mixture of claim 1, wherein at least one R² is derived from a hydrophobic cationic monomer having the chemical formula of (III), and wherein:
R³ is a methyl group,
K is —C(O)NH—,
n is equal to 3,
R⁴ is a methyl group,
R⁵ is a methyl group,
L is —CH₂—CH(OH)—CH₂—,
two of R⁶, R⁷, and R⁸ are a methyl group,
one of R⁶, R⁷, and R⁸ is a linear C18 alkyl group, and
X⁻ is a counter ion selected from the group consisting of: chloride, bromide, iodide, hydroxide, phosphate, sulfate, hydrosulfate, ethyl sulfate, methyl sulfate, formate, and acetate.

10. The resin mixture of claim 1, wherein at least one R² is derived from a hydrophobic cationic monomer having the chemical formula of (IV), and wherein:
R⁴ is a linear C12 alkyl group,
R⁵ is a linear C12 alkyl group, and
X⁻ is a counter ion selected from the group consisting of: chloride, bromide, iodide, hydroxide, phosphate, sulfate, hydrosulfate, ethyl sulfate, methyl sulfate, formate, and acetate.

11. The resin mixture of claim 1, wherein at least one R² is derived from a hydrophobic cationic monomer having the chemical formula of (III), and wherein L comprises one or more heteroatoms, one or more heterogroups, or a combination thereof.

12. The resin mixture of claim 11, wherein the one or more heteroatoms comprises 0, and wherein the one or more heterogroups comprises NH.

13. The resin mixture of claim 1, wherein at least one R² is derived from a hydrophobic cationic monomer having the chemical formula of (III), and wherein L is substituted with one or more hydroxy groups, one or more amino groups, or a combination thereof.

14. The resin mixture of claim 1, wherein the solvent is water and the resin mixture comprises about 5 wt % to about 25 wt % of the strengthening resin, based on a combined weight of the strengthening resin and water.

15. The resin mixture of claim 14, wherein the resin mixture has a viscosity of about 3 cP to about 200 cP at a temperature of about 25° C., as measured using a Brookfield DV-E Viscometer, spindle 61/62 at 60 rpm.

16. The resin mixture of claim 1, wherein the strengthening resin has a weight average molecular weight of about 50 kDa to about 5,000 kDa.

17. The resin mixture of claim 1, wherein each A repeating unit is derived from acrylamide, methacrylamide, or a mixture thereof.

18. The resin mixture of claim 1, wherein:
the solvent comprises water,
the resin mixture comprises about 3 wt % to about 30 wt % of the strengthening resin based on a combined weight of the solvent and the strengthening resin,
the aldehyde comprises formaldehyde, paraformaldehyde, glutaraldehyde, glyoxal, malondialdehyde, succindialdehyde, or a mixture thereof,
each A repeating unit is derived from acrylamide, methacrylamide, or acrylamide and methacrylamide,
each A-D moiety is derived from a reaction between an A repeating unit and an aldehyde comprising glyoxal,
each A-E-A moiety is derived from a reaction between two A repeating units and glyoxal,
each G is derived from diallyldimethyl ammonium chloride, acrylic acid, methacrylic acid, 2-dimethylaminoethyl acrylate methyl chloride quaternary salt, 2-dimethylaminoethyl methacrylate methyl chloride quaternary salt, or a mixture thereof, and
at least one R² is derived from a hydrophobic cationic monomer having the chemical formula of (II), wherein:
R³ is a hydrogen atom,
J is phenylene,
two of R⁴, R⁵, and R⁶ are a methyl group,
one of R⁴, R⁵, and R⁶ is a linear C18 alkyl group,
m is equal to 1, and
X⁻ is a counter ion selected from the group consisting of: chloride, bromide, iodide, hydroxide, phosphate, sulfate, hydrosulfate, ethyl sulfate, methyl sulfate, formate, and acetate.

19. The resin mixture of claim 1, wherein:
the solvent comprises water,
the resin mixture comprises about 3 wt % to about 30 wt % of the strengthening resin based on a combined weight of the solvent and the strengthening resin,
the aldehyde comprises formaldehyde, paraformaldehyde, glutaraldehyde, glyoxal, malondialdehyde, succindialdehyde, or a mixture thereof,
each A repeating unit is derived from acrylamide, methacrylamide, or acrylamide and methacrylamide,
each A-D moiety is derived from a reaction between an A repeating unit and an aldehyde comprising glyoxal,
each A-E-A moiety is derived from a reaction between two A repeating units and glyoxal,
each G is derived from diallyldimethyl ammonium chloride, acrylic acid, methacrylic acid, 2-dimethylaminoethyl acrylate methyl chloride quaternary salt, 2-dimethylaminoethyl methacrylate methyl chloride quaternary salt, or a mixture thereof, and
at least one R² is derived from a hydrophobic cationic monomer having the chemical formula of (III), and wherein:
R³ is a methyl group,
K is —C(O)NH—,
n is equal to 3,
R⁴ is a methyl group,
R⁵ is a methyl group,
L is —CH₂—CH(OH)—CH₂—,
two of R⁶, R⁷, and R⁸ are a methyl group,
one of R⁶, R⁷, and R⁸ is a linear C18 alkyl group, and
X⁻ is a counter ion selected from the group consisting of: chloride, bromide, iodide, hydroxide, phosphate, sulfate, hydrosulfate, ethyl sulfate, methyl sulfate, formate, and acetate

20. The resin mixture of claim 1, wherein:
the solvent comprises water,
the resin mixture comprises about 3 wt % to about 30 wt % of the strengthening resin based on a combined weight of the solvent and the strengthening resin,
the aldehyde comprises formaldehyde, paraformaldehyde, glutaraldehyde, glyoxal, malondialdehyde, succindialdehyde, or a mixture thereof,
each A repeating unit is derived from acrylamide, methacrylamide, or acrylamide and methacrylamide,
each A-D moiety is derived from a reaction between an A repeating unit and an aldehyde comprising glyoxal,
each A-E-A moiety is derived from a reaction between two A repeating units and glyoxal,
each G is derived from diallyldimethyl ammonium chloride, acrylic acid, methacrylic acid, 2-dimethylaminoethyl acrylate methyl chloride quaternary salt, 2-dimethylaminoethyl methacrylate methyl chloride quaternary salt, or a mixture thereof, and
at least one R² is derived from a hydrophobic cationic monomer having the chemical formula of (IV), and wherein:
R⁴ is a linear C12 alkyl group,
R⁵ is a linear C12 alkyl group, and
X⁻ is a counter ion selected from the group consisting of: chloride, bromide, iodide, hydroxide, phosphate, sulfate, hydrosulfate, ethyl sulfate, methyl sulfate, formate, and acetate.
